(19) United States
(12) Patent Application Publication
(10) Pub. No.: US 2023/0213732 A1
(43) Pub. Date: Jul. 6, 2023

(54) OPTICAL SYSTEM AND IMAGE PICKUP APPARATUS HAVING THE SAME

(71) Applicant: CANON KABUSHIKI KAISHA, Tokyo (JP)

(72) Inventor: Takahiro HATADA, Tochigi (JP)

(21) Appl. No.: 18/068,651

(22) Filed: Dec. 20, 2022

(30) Foreign Application Priority Data
Jan. 1, 2022 (JP) 2022-000013

(51) Int. Cl. G02B 9/34

(52) U.S. Cl. CPC G02B 9/34; G02B 27/0025

(57) ABSTRACT

An optical system includes, in order from an object side to an image side, a first lens unit having positive refractive power, a second lens unit having negative refractive power, a third lens unit having positive refractive power, and a fourth lens unit having positive refractive power. During focusing, the first lens unit and the fourth lens unit are fixed, and the second lens unit and the third lens unit are moved. The first lens unit includes a positive lens disposed closest to an object. The fourth lens unit includes a negative lens disposed closest to an image plane.

### BACKGROUND

### Technical Field

One of the aspects of the disclosure relates to an optical system, which is suitable for a digital video camera, a digital still camera, a broadcasting camera, a film-based camera, a surveillance camera, and the like.

### Description of the Related Art

An optical system for an image pickup apparatus has recently been demanded to achieve miniaturization of an overall lens diameter of the focus lens unit, to increase imaging magnification, and to satisfactory correct chromatic aberration, curvature of field, and the like during imaging at the shortest distance. As an optical system that meets these demands, Japanese Patent Laid-Open No. (“JP”) 2017-173409 discloses an optical system that includes, in order from the object side to the image side, a first lens unit having positive refractive power, a focus lens unit having negative refractive power, and a focus lens unit having positive refractive power.

The optical system described in JP 2017-173409 reduces aberration fluctuations, in particular, chromatic aberration fluctuations during focusing, and has high optical performance over a wide object distance range.

However, in the optical system described in JP 2017-173409, in a case where the optical system is made to have a large aperture (diameter), a relationship between the focal length of the focus lens unit having positive refractive power and the focal length of the fourth lens unit disposed on the image side of this focus lens unit is not properly set. It is thus difficult for the optical system described in JP 2017-173409 to suppress aberration fluctuations during focusing in the case where the optical system is made to have a large aperture.

### SUMMARY

One of the aspects of the disclosure provides an optical system that can satisfactorily correct aberrations over a wide object distance range and achieve miniaturization of a focus lens unit.

An optical system according to one aspect of the disclosure includes, in order from an object side to an image side, a first lens unit having positive refractive power, a second lens unit having negative refractive power, a third lens unit having positive refractive power, and a fourth lens unit having positive refractive power. During focusing, the first lens unit and the fourth lens unit are fixed, and the second lens unit and the third lens unit are moved. The first lens unit includes a positive lens disposed closest to an object. The fourth lens unit includes a negative lens disposed closest to an image plane. The image pickup apparatus having the above optical system also constitutes another aspect of the disclosure.

Further features of the disclosure will become apparent from the following description of exemplary embodiments with reference to the attached drawings.

### BRIEF DESCRIPTION OF THE DRAWINGS

FIG. 1 is a sectional view of an optical system according to Example 1.

FIG. 2 is a longitudinal aberration diagram of the optical system according to Example 1 in an in-focus state at infinity.

FIG. 3 is a longitudinal aberration diagram of the optical system according to Example 1 in an in-focus state at a short distance (0.70 m).

FIG. 4 is a sectional view of an optical system according to Example 2.

FIG. 5 is a longitudinal aberration diagram of the optical system according to Example 2 in an in-focus state at infinity.

FIG. 6 is a longitudinal aberration diagram of the optical system according to Example 2 in an in-focus state at a short distance (0.60 m).

FIG. 7 is a sectional view of an optical system according to Example 3.

FIG. 8 is a longitudinal aberration diagram of the optical system according to Example 3 in an in-focus state at infinity.

FIG. 9 is a longitudinal aberration diagram of the optical system according to Example 3 in an in-focus state at a short distance (0.70 m).

FIG. 10 is a sectional view of an optical system according to Example 4.

FIG. 11 is a longitudinal aberration diagram of the optical system according to Example 4 in an in-focus state at infinity.

FIG. 12 is a longitudinal aberration diagram of the optical system according to Example 4 in an in-focus state at a short distance (0.85 m).

FIG. 13 is a schematic diagram of an image pickup apparatus.

### DESCRIPTION OF THE EMBODIMENTS

Referring now to the accompanying drawings, a description will be given of an example of an optical system of the disclosure and an image pickup apparatus having the same.

FIGS. 1, 4, 7, and 10 are sectional views of optical systems according to Examples 1 to 4, respectively, in an in-focus state at infinity (on an object at infinity or infinity object). The optical system L0 according to each example is an optical system for an image pickup apparatus such as a digital video camera, a digital still camera, a broadcast camera, a film-based camera, and a surveillance camera.

In each lens sectional view, a left side is an object side and a right side is an image side. The optical system L0 according to each example includes a plurality of lens units. In the specification of this application, a lens unit is a group of lenses that are integrally moved or fixed during focusing. That is, in the optical system L0 according to each example, a distance between adjacent lens units changes during focusing from infinity to the shortest distance. The lens unit may include one or more lenses. The lens unit may include an aperture stop.

In each lens sectional view, Li denotes an i-th lens unit (where i is a natural number) counted from the object side among the lens units included in the optical system L0.

SP denotes an aperture stop (diaphragm). IP is an image plane. In a case where the optical system L0 according to each example is used as an imaging optical system for a digital still camera or a digital video camera, an imaging plane of a solid-state image sensor (photoelectric conversion element) such as a CCD sensor or a CMOS sensor is placed on the image plane IP. In a case where the optical system L0 according to each example is used as an imaging optical system for a film-based camera, a photosensitive surface corresponding to the film plane is placed on the image plane IP.

In each lens sectional view according to Examples 1 to 4, reference numeral L1 denotes a first lens unit having positive refractive power, reference numeral L2 denotes a second lens unit having negative refractive power, reference numeral L3 denotes a third lens unit having positive refractive power, and reference numeral L4 denotes a fourth lens unit having positive refractive power.

In the optical systems L0 according to Examples 1 to 4, the second lens unit L2 is moved toward the image side and the third lens unit L3 is moved toward the object side as indicated by arrows during focusing from infinity to the shortest distance. The first lens unit L1 and the fourth lens unit L4 are stationary (fixed) during focusing from infinity to the shortest distance. The second lens unit L2 and the third lens unit L3 are moved with different loci during focusing.

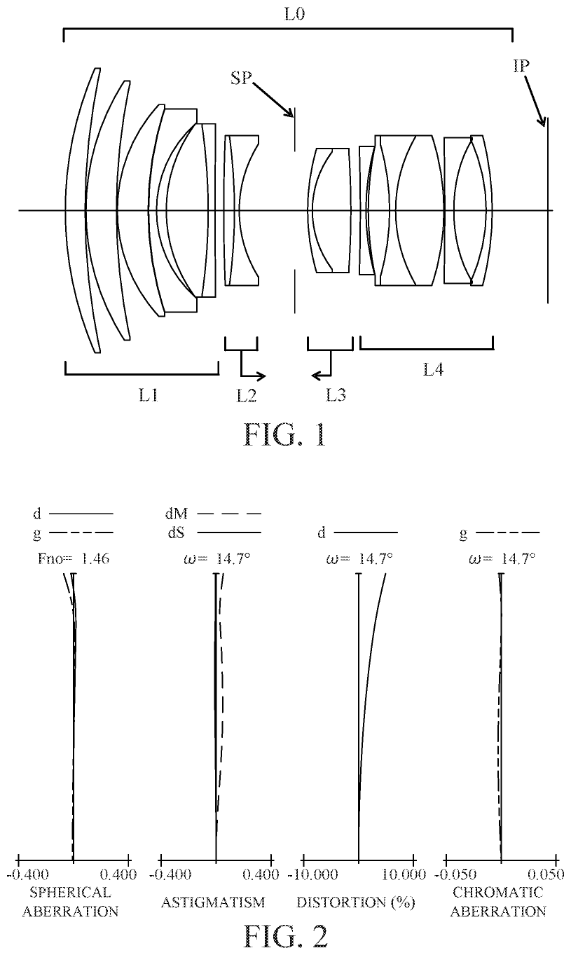

FIGS. 2, 5, 8, and 11 are aberration diagrams of the optical systems L0 according to Examples 1 to 4, respectively, in the in-focus state at infinity.

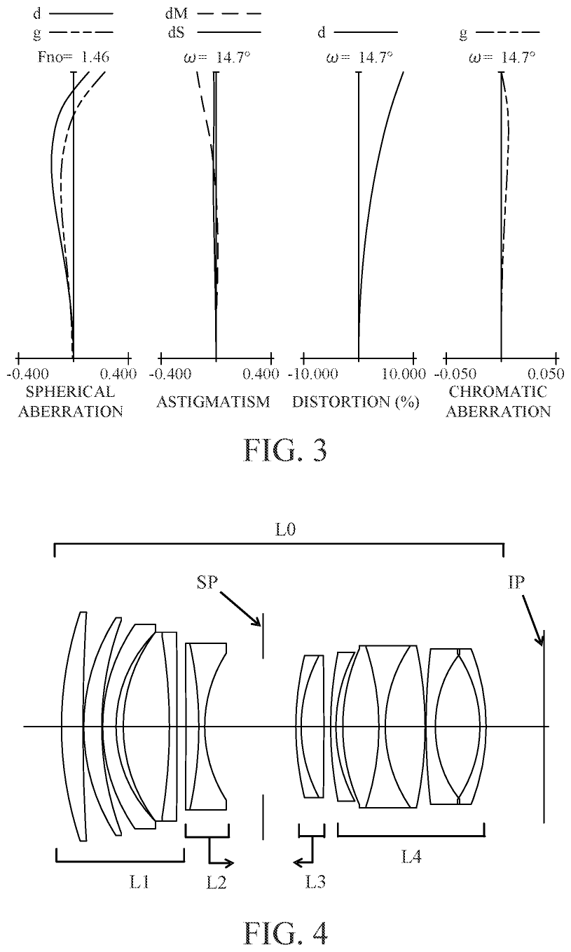

FIGS. 3, 6, 9, and 12 are aberration diagrams of the optical systems L0 according to Examples 1 to 4, respectively, in an in-focus state at a short distance.

In a spherical aberration diagram, Fno denotes an F-number, which indicates spherical aberration amounts for the d-line (wavelength 587.6 nm) and the g-line (wavelength 435.8 nm). In an astigmatism diagram, dS denotes an astigmatism amount on a sagittal image plane, and dM denotes an astigmatism amount on a meridional image plane. A distortion diagram illustrates a distortion amount for the d-line. A chromatic aberration diagram illustrates a chromatic aberration amount for the g-line. ω is an imaging half angle of view (°).

A description will now be given of a characteristic configuration of the optical system L0 according to each example.

The optical system L0 according to each example includes, in order from the object side to the image side, a first lens unit L1 having positive refractive power, a second lens unit L2 having negative refractive power, a third lens unit L3 having positive refractive power, and a fourth lens unit L4 having positive refractive power. In the optical system L0 according to each example, the first lens unit L1 and the fourth lens unit L4 are fixed during focusing, and the second lens unit L2 and the third lens unit L3 are moved during focusing. As described above, the optical system L0 according to each example includes a four-unit configuration of positive, negative, positive, and positive refractive powers, and the second lens unit L2 and the third lens unit L3 are independently moved during focusing. The fourth lens unit serving as the final lens unit and having positive refractive power can reduce the refractive power of the third lens unit L3 that has positive refractive power and moves during focusing, thereby satisfactorily correcting spherical aberration at a short distance.

The first lens unit L1 includes a lens unit having positive refractive power (positive lens) disposed closest to the object. Thereby, the diameters of the second lens unit L2 and the third lens unit L3 as the focus lens units can be reduced, and the size and weight of the focus lens unit can be reduced.

The fourth lens unit L4 includes a lens having negative refractive power (negative lens) disposed closest to the image plane. This configuration can adopt a telephoto-type power arrangement and shorten the overall lens length.

A description will now be given of the configuration that may be satisfied by the optical system L0 according to each example.

The second lens unit L2 may be moved toward the image side during focusing from infinity to the shortest distance. This configuration can suppress curvature of field and spherical aberration during focusing from infinity to the shortest distance, and suppress changes in the angle of view during moving image capturing. The third lens unit L3 may be moved toward the object during focusing from infinity to the shortest distance. By moving the third lens unit L3 as a main focus lens unit having refractive power with an opposite sign to that of the refractive power of the second lens unit L2, in a direction opposite to that of the second lens unit L2, spherical aberration and curvature of field can be more satisfactorily corrected.

A distance on the optical axis between the second lens unit L2 and the third lens unit L3 may be the longest distance of all distances on the optical axis between adjacent lens units in the optical system L0. Thereby, a sufficient moving amount of the focus lens unit can be secured, and the shortest imaging distance can be reduced. In addition, the refractive power of the focus lens unit can be reduced, and curvature of field and spherical aberration can be suppressed during focusing.

Each of the second lens unit L2 and the third lens unit L3 may include three lenses or fewer. The focus lens unit including a small number of lenses can provide quick focusing even with a large aperture.

The fourth lens unit L4 may include two negative lenses or more. The fourth lens unit L4 including a plurality of negative lenses can correct the Petzval sum, and satisfactorily correct the curvature of field with a reduced overall lens length.

A description will now be given of configurations that may be satisfied by the optical system L0 according to each example. The optical system L0 according to each example may satisfy one or more of the following inequalities (1) to (9):

0.4<f1/f<1.5 (1)

−1.0<f2/f<−0.3 (2)

0.8<f3/f<5.0 (3)

0.5<f4/f<4.0 (4)

−1.5<M3/M2<0.0 (5)

0.5<(rf+rr)/(rf−rr)<1.5 (6)

0.5<D23/sk<3.0 (7)

3.0<f4/sk<40.0 (8)

−2.0<fno×f2/f3<0.0 (9)

Here, f is a focal length of the optical system L0. f1 is a focal length of the first lens unit L1. f2 is a focal length of the second lens unit L2. f3 is a focal length of the third lens unit L3. f4 is a focal length of the fourth lens unit L4. M2 is a moving amount of the second lens unit L2 relative to the image plane IP during focusing from infinity to the shortest distance, where a direction in which the second lens unit L2 moves from the object side to the image side is set positive. M3 is a moving amount of the third lens unit L3 relative to the image plane IP during focusing from infinity to the shortest distance, where a direction in which the third lens unit L3 moves from the object side to the image side is set positive. rf is a radius of curvature of a lens surface on the object side of a lens disposed closest to the object in the second lens unit L2. rr is a radius of curvature of a lens surface on the image side of a lens disposed closest to the image plane in the second lens unit L2. sk is a back focus of the optical system L0 in the in-focus state at infinity. D23 is a distance on the optical axis between the second lens unit L2 and the third lens unit L3 in the in-focus state at infinity. That is, D23 is a distance on the optical axis from a lens surface closest to the image plane of the second lens unit L2 to a lens surface closest to the object of the third lens unit L3 in the in-focus state at infinity. fno is an F-number of the optical system L0.

Inequality (1) defines a ratio between the focal length f1 of the first lens unit L1 and the focal length f of the optical system L0. Satisfying inequality (1) can shorten the overall lens length and reduce the weight of the focus lens unit. In a case where the focal length f1 of the first lens unit L1 becomes so short that the value is lower than the lower limit of inequality (1), correction of spherical aberration becomes difficult. In a case where the focal length f1 of the first lens unit L1 becomes so long that the value is higher than the upper limit of inequality (1), the convergence effect of the first lens unit L1 weakens and the overall lens length increases. As a result, the diameters of the second lens unit L2 and the third lens unit L3 become large, and it becomes difficult to reduce the weight of the focus lens unit.

Inequality (2) defines a ratio between the focal length f2 of the second lens unit L2 and the focal length f of the optical system L0. In a case where the focal length f2 of the second lens unit L2 becomes so long that the value is lower than the lower limit of inequality (2), the moving amount of the second lens unit L2 during focusing increases. Thus, it becomes difficult to reduce the overall lens length. In a case where the focal length f2 of the second lens unit L2 becomes so short that the value is higher than the upper limit of inequality (2), it becomes difficult to suppress curvature of field and spherical aberration during focusing.

Inequality (3) defines a ratio between the focal length f3 of the third lens unit L3 and the focal length f of the optical system L0. In a case where the focal length f3 of the third lens unit L3 becomes so short that the value is lower than the lower limit of inequality (3), it becomes difficult to suppress curvature of field and spherical aberration during focusing. In a case where the focal length f3 of the third lens unit L3 becomes so long that the value is higher than the upper limit of inequality (3), the moving amount of the third lens unit L3 during focusing increases. Thus, it becomes difficult to reduce the overall lens length.

Inequality (4) defines a ratio between the focal length f4 of the fourth lens unit L4 and the focal length f of the optical system L0. In a case where the focal length f4 of the fourth lens unit L4 becomes so short that the value is lower than the lower limit of inequality (4), the positive refractive power of the third lens unit L3 becomes relatively weak, and the moving amount of the second lens unit L2 during focusing increases. Thus, it becomes difficult to reduce the overall lens length. In a case where the focal length f4 of the fourth lens unit L4 becomes so long that the value is higher than the upper limit of inequality (4), the positive refractive power of the third lens unit L3 becomes relatively strong, and it becomes difficult to suppress curvature of field and spherical aberration during focusing.

Inequality (5) defines a ratio between the moving amount M2 of the second lens unit L2 as the focus lens unit, and the moving amount M3 of the third lens unit L3 as the focus lens unit. In a case where the moving amount M2 of the second lens unit L2 becomes so small that the value is lower than the lower limit of inequality (5), it becomes difficult to suppress spherical aberration during focusing. In a case where the moving amount of the third lens unit L3 toward the object side becomes so large that the value is higher than the upper limit of inequality (5), it becomes difficult to reduce the shortest object distance, and the overall length of the lens increases.

Inequality (6) defines a shape factor of the second lens unit L2 as the focus lens unit. In a case where the radius of curvature rf of the lens surface closest to the object of the second lens unit L2 becomes small in the negative region and the value is lower than the lower limit of inequality (6), it becomes difficult to suppress spherical aberration during focusing. In a case where the radius of curvature rr of the lens surface closest to the image plane of the second lens unit L2 becomes small and the value is higher than the upper limit of inequality (6), it becomes difficult to suppress curvature of field during focusing.

Inequality (7) defines a ratio between the distance D23 on the optical axis between the second lens unit L2 and the third lens unit L3 and the back focus sk. In a case where the distance D23 between the second lens unit L2 and the third lens unit L3 becomes so narrow that the value is lower than the lower limit of inequality (7), it becomes difficult to reduce the shortest object distance. In addition, it is difficult to suppress curvature of field and spherical aberration during focusing. In a case where the distance D23 between the second lens unit L2 and the third lens unit L3 becomes so wide that the value is higher than the upper limit of inequality (7), it becomes difficult to reduce the overall lens length.

Inequality (8) defines a ratio between the focal length f4 of the fourth lens unit L4 and the back focus sk. In a case where the focal length f4 of the fourth lens unit L4 becomes so short that the value is lower than the lower limit of inequality (8), it becomes difficult to reduce the overall lens length. In a case where the focal length f4 of the fourth lens unit L4 becomes so long that the value is higher than the upper limit of inequality (8), it becomes difficult to secure the back focus sk.

Inequality (9) defines a relationship between the F-number fno of the optical system L0 and a ratio between the focal lengths f2 and f3 of the focus lens units L2 and L3. In a case where the focal length f2 of the second lens unit L2 becomes so long that the value is lower than the lower limit of inequality (9), the moving amount of the second lens unit L2 during focusing increases. It becomes thus difficult to reduce the overall lens length. Moreover, it becomes difficult to obtain a desired large aperture ratio. In a case where the focal length f2 of the second lens unit L2 becomes so short that the value is higher than the upper limit of inequality (9), it becomes difficult to suppress curvature of field and spherical aberration during focusing.

Inequalities (1) to (9) may be replaced with inequalities (1a) to (9a) below.

0.5<f1/f<1.3 (1a)

−0.9<f2/f<−0.35 (2a)

1.0<f3/f<4.5 (3a)

0.6<f4/f<3.0 (4a)

−1.5<M3/M2<−0.05 (5a)

0.6<(rf+rr)/(rf−rr)<1.3 (6a)

0.8<D23/sk<2.5 (7a)

4.0<f4/sk<30.0 (8a)

−1.5<fno×f2/f3<−0.05 (9a)

Inequalities (1) to (9) may be replaced with inequalities (1b) to (9b) below.

0.6<f1/f<1.1 (1b)

−0.8<f2/f<−0.4 (2b)

1.2<f3/f<4.0 (3b)

0.7<f4/f<2.0 (4b)

−1.5<M3/M2<−0.08 (5b)

0.7<(rf+rr)/(rf−rr)<1.2 (6b)

1.0<D23/sk<2.0 (7b)

5.0<f4/sk<20.0 (8b)

−1.0<fno×f2/f3<−0.1 (9b)

By satisfying at least one of the above inequalities, it becomes easy to satisfactorily correct aberrations over a wide object distance range while miniaturization of the focus lens unit is achieved.

A detailed description will be given of the optical system L0 according to each example.

### Example 1

FIG. 1 is a sectional view of the optical system L0 according to Example 1 in the in-focus state at infinity, FIG. 2 is an aberration diagram of the optical system L0 according to Example 1 in the in-focus state at infinity, and FIG. 3 is an aberration diagram of the optical system L0 according to Example 1 in the in-focus state at a short distance (0.70 m).

The optical system L0 according to Example 1 includes, in order from the object side to the image side, a first lens unit L1 having positive refractive power, a second lens unit L2 having negative refractive power, a third lens unit L3 having positive refractive power, and a fourth lens unit L4 having positive refractive power. The aperture stop SP is disposed between the second lens unit L2 and the third lens unit L3. During focusing from infinity to the shortest distance, the second lens unit L2 is moved toward the image side, and the third lens unit L3 is moved toward the object side.

As illustrated in the aberration diagrams of FIGS. 2 and 3, this configuration can provide a small optical system that can satisfactorily correct various aberrations over the entire object distance.

### Example 2

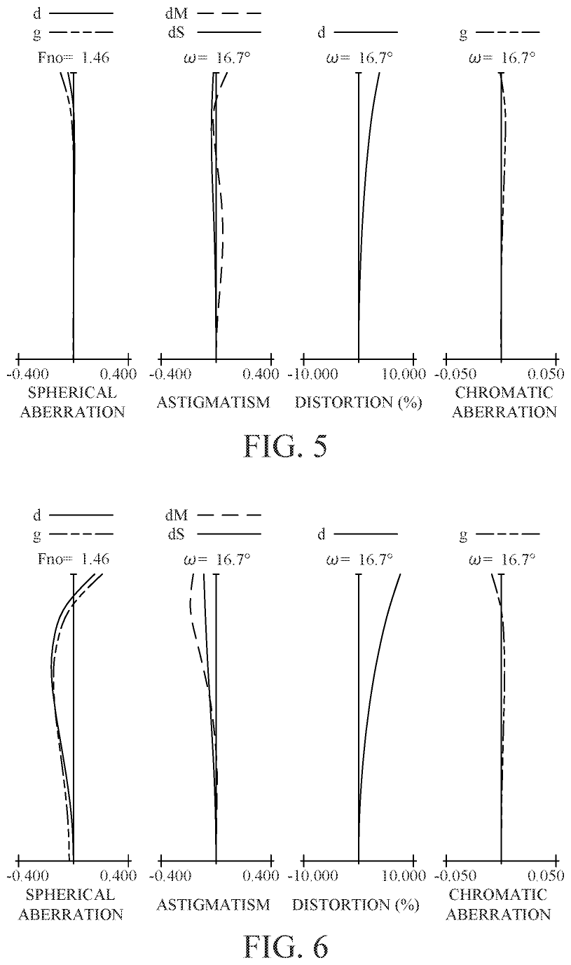

FIG. 4 is a sectional view of the optical system L0 according to Example 2 in the in-focus state at infinity, FIG. 5 is an aberration diagram of the optical system L0 according to Example 2 in the in-focus state at infinity, and FIG. 6 is an aberration diagram of the optical system L0 according to Example 2 in the in-focus state at a short distance (0.60 m).

The optical system L0 according to Example 2 includes, in order from the object side to the image side, a first lens unit L1 having positive refractive power, a second lens unit L2 having negative refractive power, a third lens unit L3 having positive refractive power, and a fourth lens unit L4 having positive refractive power. The aperture stop SP is disposed between the second lens unit L2 and the third lens unit L3. During focusing from infinity to the shortest distance, the second lens unit L2 is moved toward the image side, and the third lens unit L3 is moved toward the object side.

As illustrated in the aberration diagrams of FIGS. 5 and 6, this configuration can provide a small optical system that can satisfactorily correct various aberrations over the entire object distance.

### Example 3

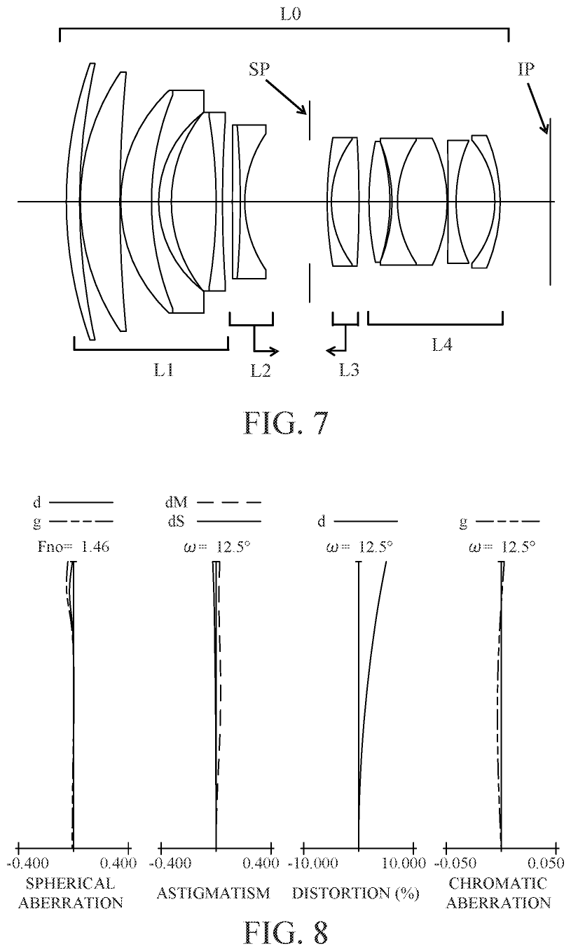

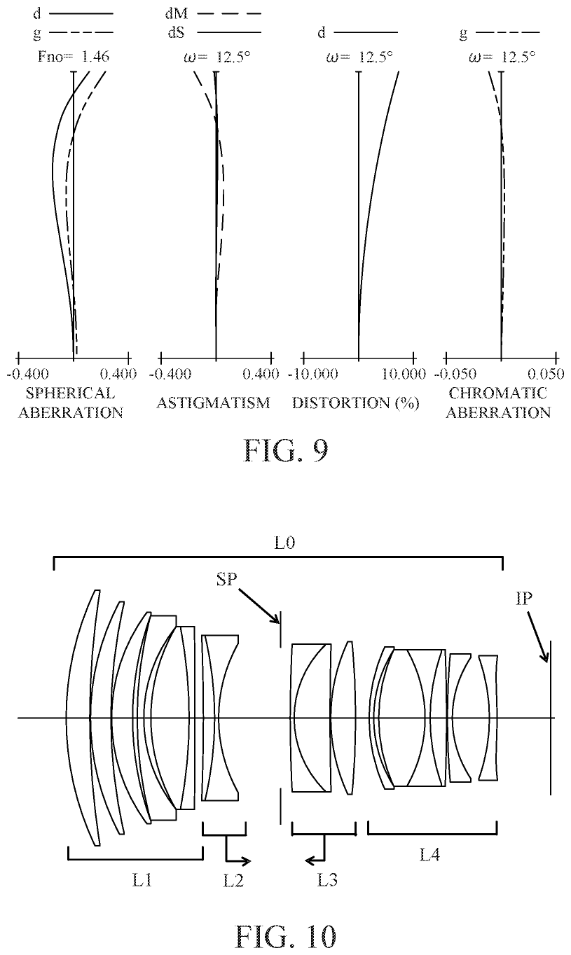

FIG. 7 is a sectional view of the optical system L0 according to Example 3 in the in-focus state at infinity, FIG. 8 is an aberration diagram of the optical system L0 according to Example 3 in the in-focus state at infinity, and FIG. 9 is an aberration diagram of the optical system L0 according to Example 3 in the in-focus state at a short distance (0.70 m).

The optical system L0 according to Example 3 includes, in order from the object side to the image side, a first lens unit L1 having positive refractive power, a second lens unit L2 having negative refractive power, a third lens unit L3 having positive refractive power, and a fourth lens unit L4 having positive refractive power. The aperture stop SP is disposed between the second lens unit L2 and the third lens unit L3. During focusing from infinity to the shortest distance, the second lens unit L2 is moved toward the image side, and the third lens unit L3 is moved toward the object side.

As illustrated in the aberration diagrams of FIGS. 8 and 9, this configuration can provide a small optical system that can satisfactorily correct various aberrations over the entire object distance.

### Example 4

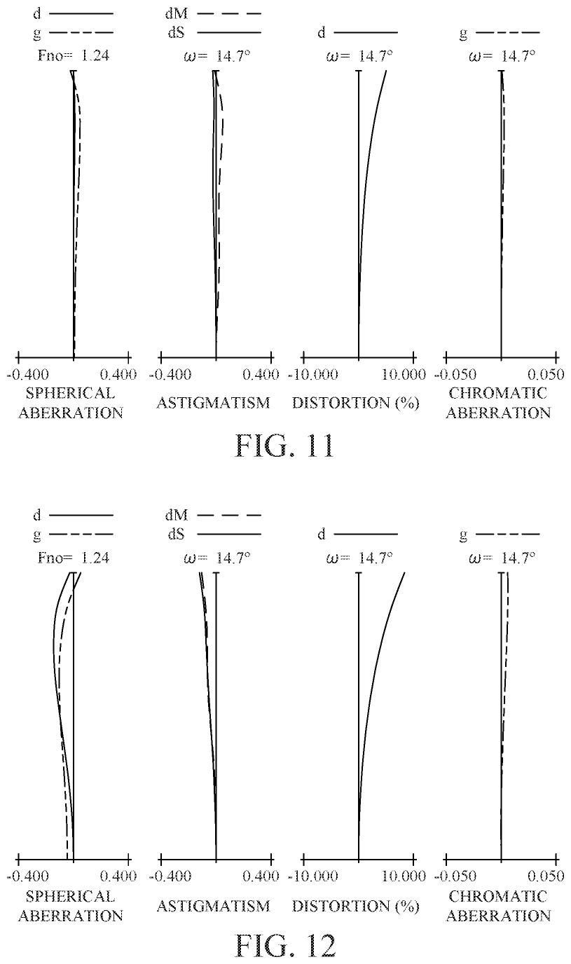

FIG. 10 is a sectional view of the optical system L0 according to Example 4 in the in-focus state at infinity, FIG. 11 is an aberration diagram of the optical system L0 according to Example 4 in the in-focus state at infinity, and FIG. 12 is an aberration diagram of the optical system L0 according to Example 4 in the in-focus state at a short distance (0.85 m).

The optical system L0 according to Example 4 includes a first lens unit L1 having positive refractive power, a second lens unit L2 having negative refractive power, a third lens unit L3 having positive refractive power, and a fourth lens unit L4 having positive refractive power. The aperture stop SP is disposed between the second lens unit L2 and the third lens unit L3. During focusing from infinity to the shortest distance, the second lens unit L2 is moved toward the image side, and the third lens unit L3 is moved toward the object side.

As illustrated in the aberration diagrams of FIGS. 11 and 12, this configuration can provide a small optical system that can satisfactorily correct various aberrations over the entire object distance.

Numerical examples 1 to 4 corresponding to Examples 1 to 4 will be illustrated below.

In surface data in each numerical example, r denotes a radius of curvature of each optical surface, and d (mm) denotes an on-axis distance (or a distance on the optical axis) between an m-th surface and an (m+1)-th surface, where m is a surface number counted from the light incident side. nd denotes a refractive index for the d-line of each optical element, and vd denotes an Abbe number of the optical element. The Abbe number vd of a certain material is expressed as follows:

vd=(Nd−1)/(NF−NC)

where Nd, NF, and NC are refractive indexes with respect to the d-line (587.6 nm), the F-line (486.1 nm), and the C-line (656.3 nm) in the Fraunhofer line, respectively.

In each numerical example, each of d, a focal length (mm), an F-number, and half an angle of view (°) has a value in a case where the optical system L0 according to each example is in the in-focus state on an object at infinity (infinity object). Aback focus BF is a distance on the optical axis from the final lens surface (the lens surface closest to the image plane or image sensor) to a paraxial image plane in terms of air equivalent length. An overall lens length is a length obtained by adding the back focus to a distance on the optical axis from the first surface (lens surface closest to the object or farthest from the image sensor) to the final surface of the zoom lens. The lens unit includes one or more lenses.

In a case where the optical surface is aspherical, an asterisk * is attached to the right side of the surface number. The aspherical shape is expressed as follows:

x=(h²/R)/[1+{1−(1+k)(h/R)²}^{1/2}]+A4×h⁴+A6×h⁶+A8×h⁸+A10×h¹⁰+A12×h¹²

where x is a displacement amount from a surface vertex in the optical axis direction, h is a height from the optical axis in a direction orthogonal to the optical axis, R is a paraxial radius of curvature, k is a conical constant, A4, A6, A8, A10, and A12 are aspherical coefficients of respective orders. “e±XX” in each aspherical coefficient means “×10^{±XX}.”

[NUMERICAL EXAMPLE 1]
UNIT: mm
Surface Data

| Surface | | | | | Effective |
|---|---|---|---|---|---|
| No. | r | d | nd | νd | Diameter |
| 1 | 83.161 | 4.61 | 1.92286 | 20.9 | 64.00 |
| 2 | 154.104 | 0.20 | | | 63.04 |
| 3 | 55.552 | 7.11 | 1.59522 | 67.7 | 58.36 |
| 4 | 140.805 | 0.20 | | | 56.63 |
| 5 | 36.359 | 7.19 | 1.59522 | 67.7 | 47.90 |
| 6 | 74.943 | 0.10 | | | 45.96 |
| 7 | 76.130 | 1.85 | 1.72825 | 28.5 | 45.92 |
| 8 | 27.070 | 2.28 | | | 39.06 |
| 9 | 33.607 | 9.78 | 1.49700 | 81.5 | 38.98 |
| 10 | −136.952 | 1.60 | 1.85478 | 24.8 | 37.31 |
| 11 | 1655.784 | (Variable) | | | 35.78 |
| 12 | 397.704 | 2.52 | 1.80810 | 22.8 | 33.49 |
| 13 | −128.213 | 1.10 | 1.77250 | 49.6 | 32.86 |
| 14 | 29.115 | (Variable) | | | 29.31 |
| 15(SP) | ∞ | (Variable) | | | 27.81 |
| 16 | 50.963 | 1.10 | 1.85478 | 24.8 | 27.01 |
| 17 | 22.681 | 8.99 | 1.61800 | 63.4 | 25.88 |
| 18 | −192.160 | (Variable) | | | 24.98 |
| 19 | −442.565 | 1.30 | 1.78472 | 25.7 | 26.89 |
| 20 | 55.512 | 0.54 | | | 28.41 |
| 21 | 73.672 | 4.97 | 1.91082 | 35.2 | 28.57 |
| 22 | −56.192 | 1.40 | 1.61293 | 37.0 | 29.34 |
| 23 | 34.359 | 11.27 | 2.00100 | 29.1 | 32.76 |
| 24 | −55.407 | 0.20 | | | 33.35 |
| 25 | −785.674 | 2.10 | 1.69350 | 53.2 | 32.33 |
| 26* | 38.858 | 7.55 | | | 31.08 |
| 27 | −39.599 | 1.40 | 1.60311 | 60.6 | 31.39 |
| 28 | −69.004 | 13.00 | | | 33.00 |
| Image Plane | ∞ | | | | |

Aspheric Data

26th Surface
K = 0.00000e+00 A 4 = 5.44228e−06 A 6 = 1.32152e−09
A 8 = 3.52234e−11 A10 = −6.99292e−14 A12 = 1.27529e−16

Various Data

| | |
|---|---|
| Focal Length | 82.50 |
| FNO | 1.46 |
| Half Angle of View (°) | 14.69 |
| Image Height | 21.64 |
| Overall lens length | 112.50 |
| BF | 13.00 |

| | Infinity | Shortest |
|---|---|---|
| d11 | 2.00 | 9.00 |
| d14 | 12.96 | 5.96 |
| d15 | 2.99 | 1.50 |
| d18 | 2.20 | 3.69 |

Lens Unit Data

| Lens Unit | Starting Surface | Focal Length |
|---|---|---|
| 1 | 1 | 60.14 |
| 2 | 12 | −41.48 |
| SP | 15 | ∞ |
| 3 | 16 | 105.20 |
| 4 | 19 | 118.83 |

Single Lens Data

| Lens | Starting Surface | Focal Length |
|---|---|---|
| 1 | 1 | 189.82 |
| 2 | 3 | 149.50 |
| 3 | 5 | 110.94 |
| 4 | 7 | −58.61 |
| 5 | 9 | 55.35 |
| 6 | 10 | −147.92 |
| 7 | 12 | 120.24 |
| 8 | 13 | −30.62 |
| 9 | 16 | −48.68 |
| 10 | 17 | 33.36 |
| 11 | 19 | −62.79 |
| 12 | 21 | 35.65 |
| 13 | 22 | −34.58 |
| 14 | 23 | 22.61 |
| 15 | 25 | −53.34 |
| 16 | 27 | −156.89 |

[NUMERICAL EXAMPLE 2]
UNIT: mm
Surface Data

| Surface | | | | | Effective |
|---|---|---|---|---|---|
| No. | r | d | nd | νd | Diameter |
| 1 | 80.607 | 4.80 | 1.61997 | 63.9 | 49.49 |
| 2 | 411.893 | 0.20 | | | 49.09 |
| 3 | 45.020 | 4.06 | 1.59522 | 67.7 | 47.11 |
| 4 | 67.726 | 0.20 | | | 46.18 |
| 5 | 39.961 | 3.00 | 1.61340 | 44.3 | 44.47 |
| 6 | 29.889 | 1.62 | | | 40.80 |
| 7 | 34.960 | 10.39 | 1.49700 | 81.5 | 40.76 |
| 8 | −127.023 | 1.70 | 1.85478 | 24.8 | 39.19 |
| 9 | −2528.692 | (Variable) | | | 37.74 |
| 10 | −1992.975 | 2.91 | 1.80810 | 22.8 | 35.85 |
| 11 | −86.475 | 1.30 | 1.72916 | 54.7 | 35.30 |
| 12 | 30.641 | (Variable) | | | 31.42 |
| 13(SP) | ∞ | (Variable) | | | 30.84 |
| 14 | 65.425 | 1.20 | 1.85478 | 24.8 | 30.24 |
| 15 | 33.708 | 5.13 | 1.61800 | 63.4 | 29.53 |
| 16 | −892.457 | (Variable) | | | 29.28 |
| 17 | 84.924 | 1.20 | 1.51633 | 64.1 | 30.58 |
| 18 | 35.214 | 1.54 | | | 31.76 |
| 19 | 43.097 | 8.14 | 1.88300 | 40.8 | 33.43 |
| 20 | −56.346 | 1.40 | 1.67270 | 32.1 | 33.76 |
| 21 | 32.150 | 8.98 | 1.88300 | 40.8 | 34.62 |
| 22 | −85.053 | 0.19 | | | 34.49 |
| 23 | 147.493 | 2.10 | 1.69350 | 53.2 | 33.03 |
| 24* | 29.488 | 10.03 | | | 30.74 |
| 25 | −29.367 | 1.40 | 1.61340 | 44.3 | 31.06 |
| 26 | −46.814 | 12.99 | | | 33.00 |
| Image Plane | ∞ | | | | |

Aspheric Data

24th Surface
K = 0.00000e+00 A 4 = 4.83027e−06 A 6 = 2.32354e−09
A 8 = 2.60591e−11 A10 = 2.17885e−14 A12 = 8.59268e−18

Various Data

| | |
|---|---|
| Focal Length | 72.10 |
| FNO | 1.46 |
| Half Angle of View (°) | 16.70 |
| Image Height | 21.64 |
| Overall lens length | 108.50 |
| BF | 12.99 |

| | Infinity | Shortest |
|---|---|---|
| d 9 | 2.01 | 8.80 |
| d12 | 13.12 | 6.33 |
| d13 | 7.37 | 1.50 |
| d16 | 1.50 | 7.37 |

Lens Unit Data

| Lens Unit | Starting Surface | Focal Length |
|---|---|---|
| 1 | 1 | 56.65 |
| 2 | 10 | −42.93 |
| SP | 13 | ∞ |
| 3 | 14 | 147.64 |
| 4 | 17 | 91.00 |

Single Lens Data

| Lens | Starting Surface | Focal Length |
|---|---|---|
| 1 | 1 | 160.76 |
| 2 | 3 | 211.49 |
| 3 | 5 | −218.02 |
| 4 | 7 | 56.36 |
| 5 | 8 | −156.51 |
| 6 | 10 | 111.79 |
| 7 | 11 | −30.88 |
| 8 | 14 | −82.79 |
| 9 | 15 | 52.67 |
| 10 | 17 | −117.48 |
| 11 | 19 | 28.76 |
| 12 | 20 | −30.24 |
| 13 | 21 | 27.41 |
| 14 | 23 | −53.54 |
| 15 | 25 | −132.50 |

[NUMERICAL EXAMPLE 3]
UNIT: mm
Surface Data

| Surface | | | | | Effective |
|---|---|---|---|---|---|
| No. | r | d | nd | νd | Diameter |
| 1 | 108.420 | 3.43 | 1.84666 | 23.8 | 69.85 |
| 2 | 163.186 | 0.20 | | | 69.12 |
| 3 | 59.780 | 10.26 | 1.59522 | 67.7 | 65.22 |
| 4 | 348.885 | 0.20 | | | 64.03 |
| 5 | 39.748 | 7.99 | 1.59522 | 67.7 | 55.56 |
| 6 | 73.013 | 1.85 | 1.67300 | 38.3 | 53.46 |
| 7 | 28.938 | 3.29 | | | 44.75 |
| 8 | 36.860 | 11.63 | 1.49700 | 81.5 | 44.62 |
| 9 | −135.341 | 1.60 | 1.85478 | 24.8 | 42.55 |
| 10 | 300.932 | (Variable) | | | 40.24 |
| 11 | 2925.902 | 2.09 | 1.80810 | 22.8 | 38.16 |
| 12 | −228.462 | 1.10 | 1.72916 | 54.7 | 37.49 |
| 13 | 31.448 | (Variable) | | | 33.64 |
| 14(SP) | ∞ | (Variable) | | | 32.35 |
| 15 | 94.094 | 1.10 | 1.85478 | 24.8 | 31.71 |
| 16 | 27.297 | 7.18 | 1.61800 | 63.4 | 30.74 |
| 17 | −262.440 | (Variable) | | | 30.63 |
| 18 | 74.274 | 5.46 | 2.00100 | 29.1 | 29.90 |
| 19 | −49.488 | 0.54 | | | 29.42 |
| 20 | −41.113 | 1.40 | 1.61340 | 44.3 | 29.40 |
| 21 | 28.815 | 12.89 | 1.57099 | 50.8 | 30.49 |
| 22 | −37.037 | 0.20 | | | 31.34 |
| 23 | −2066.129 | 2.10 | 1.69350 | 53.2 | 30.33 |
| 24* | 43.111 | 10.05 | | | 29.56 |
| 25 | −24.537 | 1.40 | 1.48749 | 70.2 | 30.25 |
| 26 | −43.452 | 13.00 | | | 32.67 |
| Image Plane | ∞ | | | | |

Aspheric Data

24th Surface
K = 0.00000e+00 A 4 = 3.17490e−06 A 6 = 1.08346e−09
A 8 = 1.01991e−11 A10 = 2.69214e−14 A12 = −5.03511e−17

Various Data

| | |
|---|---|
| Focal Length | 97.50 |
| FNO | 1.46 |
| Half Angle of View (°) | 12.51 |
| Image Height | 21.64 |
| Overall lens length | 125.50 |
| BF | 13.00 |

| | Infinity | Shortest |
|---|---|---|
| d10 | 2.60 | 12.51 |
| d13 | 16.79 | 6.87 |
| d14 | 4.58 | 1.50 |
| d17 | 2.57 | 5.65 |

Lens Unit Data

| Lens Unit | Starting Surface | Focal Length |
|---|---|---|
| 1 | 1 | 69.37 |
| 2 | 11 | −44.35 |
| SP | 14 | ∞ |
| 3 | 15 | 357.88 |
| 4 | 18 | 80.64 |

Single Lens Data

| Lens | Starting Surface | Focal Length |
|---|---|---|
| 1 | 1 | 370.91 |
| 2 | 3 | 119.62 |
| 3 | 5 | 134.52 |
| 4 | 6 | −72.45 |
| 5 | 8 | 59.63 |
| 6 | 9 | −109.03 |
| 7 | 11 | 262.32 |
| 8 | 12 | −37.84 |
| 9 | 15 | −45.33 |
| 10 | 16 | 40.39 |
| 11 | 18 | 30.34 |
| 12 | 20 | −27.41 |
| 13 | 21 | 30.56 |
| 14 | 23 | −60.87 |
| 15 | 25 | −118.50 |

[NUMERICAL EXAMPLE 4]
UNIT: mm
Surface Data

| Surface | | | | | Effective |
|---|---|---|---|---|---|
| No. | r | d | nd | νd | Diameter |
| 1 | 84.066 | 6.61 | 1.92286 | 20.9 | 69.94 |
| 2 | 225.702 | 0.20 | | | 68.82 |
| 3 | 69.879 | 5.70 | 1.59522 | 67.7 | 63.17 |
| 4 | 143.304 | 0.20 | | | 62.09 |
| 5 | 49.670 | 5.87 | 1.59522 | 67.7 | 57.14 |
| 6 | 84.792 | 1.27 | | | 55.56 |
| 7 | 112.284 | 1.85 | 1.85478 | 24.8 | 55.47 |
| 8 | 40.959 | 1.98 | | | 49.50 |
| 9 | 50.505 | 10.71 | 1.49700 | 81.5 | 49.44 |
| 10 | −134.731 | 1.60 | 1.85478 | 24.8 | 48.08 |
| 11 | −2587.955 | (Variable) | | | 46.50 |
| 12 | −555.071 | 3.16 | 1.80810 | 22.8 | 44.72 |
| 13 | −100.597 | 1.10 | 1.72916 | 54.7 | 44.25 |
| 14 | 42.976 | (Variable) | | | 40.32 |
| 15(SP) | ∞ | (Variable) | | | 39.80 |
| 16 | 396.094 | 1.10 | 1.85478 | 24.8 | 39.66 |
| 17 | 28.593 | 10.04 | 1.61800 | 63.4 | 39.09 |
| 18 | 790.704 | 0.20 | | | 39.61 |
| 19 | 50.723 | 6.98 | 1.61800 | 63.4 | 41.20 |
| 20 | −220.501 | (Variable) | | | 40.99 |
| 21 | 47.712 | 1.30 | 1.85478 | 24.8 | 38.20 |
| 22 | 35.563 | 1.39 | | | 36.81 |
| 23 | 45.775 | 12.97 | 1.91082 | 35.2 | 36.80 |
| 24 | −38.786 | 1.40 | 1.70154 | 41.2 | 36.74 |
| 25 | 55.768 | 4.62 | 2.00100 | 29.1 | 35.39 |
| 26 | −448.122 | 0.20 | | | 35.08 |
| 27 | 196.346 | 1.40 | 1.51633 | 64.1 | 34.36 |
| 28 | 30.659 | 10.38 | | | 32.17 |
| 29 | −50.491 | 2.10 | 1.69350 | 53.2 | 32.09 |
| 30* | −167.232 | 15.03 | | | 33.30 |
| Image Plane | ∞ | | | | |

Aspheric Data

30th Surface
K = 0.00000e+00 A 4 = 9.07055e−06 A 6 = −3.64062e−09
A 8 = 8.42101e−11 A10 = −2.13940e−13 A12 = 2.14692e−16

Various Data

| | |
|---|---|
| Focal Length | 82.50 |
| FNO | 1.24 |
| Half Angle of View (°) | 14.69 |
| Image Height | 21.64 |
| Overall lens length | 135.50 |
| BF | 15.03 |

| | Infinity | Shortest |
|---|---|---|
| d11 | 2.38 | 12.73 |
| d14 | 17.37 | 7.02 |
| d15 | 2.65 | 1.50 |
| d20 | 3.74 | 4.89 |

Lens Unit Data

| Lens Unit | Starting Surface | Focal Length |
|---|---|---|
| 1 | 1 | 80.89 |
| 2 | 12 | −56.54 |
| SP | 15 | ∞ |
| 3 | 16 | 116.76 |
| 4 | 21 | 127.11 |

Single Lens Data

| Lens | Starting Surface | Focal Length |
|---|---|---|
| 1 | 1 | 141.98 |
| 2 | 3 | 222.68 |
| 3 | 5 | 189.63 |
| 4 | 7 | −76.35 |
| 5 | 9 | 75.36 |
| 6 | 10 | −166.33 |
| 7 | 12 | 151.57 |
| 8 | 13 | −41.16 |
| 9 | 16 | −36.10 |
| 10 | 17 | 47.76 |
| 11 | 19 | 67.39 |
| 12 | 21 | −171.87 |
| 13 | 23 | 24.87 |
| 14 | 24 | −32.41 |
| 15 | 25 | 49.77 |
| 16 | 27 | −70.57 |
| 17 | 29 | −105.07 |

Table 1 below summarizes various values in each numerical example.

TABLE 1

| Inequality | | Ex. 1 | Ex. 2 | Ex. 3 | Ex. 4 |
|---|---|---|---|---|---|
| (1) | 0.4 < f1/f < 1.5 | 0.73 | 0.79 | 0.71 | 0.98 |
| (2) | −1.0 < f2/f < −0.3 | −0.50 | −0.60 | −0.45 | −0.69 |
| (3) | 0.8 < f3/f < 5.0 | 1.28 | 2.05 | 3.67 | 1.42 |
| (4) | 0.5 < f4/f < 4.0 | 1.44 | 1.26 | 0.83 | 1.54 |
| (5) | −1.5 < M3/M2 < 0.0 | −0.21 | −0.86 | −0.31 | −0.11 |
| (6) | 0.5 < (rf + rr)/(rf − rr) < 1.5 | 1.16 | 0.97 | 1.02 | 0.86 |
| (7) | 0.5 < D23/sk < 3.0 | 1.23 | 1.58 | 1.64 | 1.33 |
| (8) | 3.0 < f4/sk < 40.0 | 9.14 | 7.00 | 6.20 | 8.46 |
| (9) | −2.0 < fno × f2/f3 < 0.0 | −0.57 | −0.42 | −0.18 | −0.60 |

### Image Pickup Apparatus

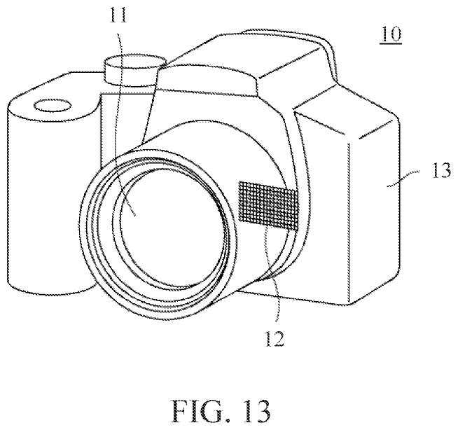

Referring now to FIG. 13, a description will now be given of an example of a digital still camera (image pickup apparatus) 10 using the optical system according to the disclosure for an imaging optical system. In FIG. 13, reference numeral 13 denotes a camera body, and reference numeral 11 denotes the imaging optical system that includes one of the optical systems L0 described in Examples 1 to 4. Reference numeral 12 denotes a solid-state image sensor (photoelectric conversion element) such as a CCD sensor or CMOS sensor, which is built in the camera body 13 and receives and photoelectrically converts an optical image formed by the imaging optical system 11. The camera body 13 may be a so-called single-lens reflex camera having a quick turn mirror, or a so-called mirror fewer camera without a quick turn mirror.

Applying the optical system of the disclosure to the image pickup apparatus such as a digital still camera can provide an image pickup apparatus having a small lens.

Each of the above examples can provide an optical system that can satisfactorily correct aberrations over a wide object distance range while miniaturization of the focus lens unit is achieved.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-000013, filed on Jan. 1, 2022, which is hereby incorporated by reference herein in its entirety.

What is claimed is:

1. An optical system comprising, in order from an object side to an image side, a first lens unit having positive refractive power, a second lens unit having negative refractive power, a third lens unit having positive refractive power, and a fourth lens unit having positive refractive power,
wherein during focusing, the first lens unit and the fourth lens unit are fixed, and the second lens unit and the third lens unit are moved,
wherein the first lens unit includes a positive lens disposed closest to an object, and
wherein the fourth lens unit includes a negative lens disposed closest to an image plane.

2. The optical system according to claim 1, wherein the following inequality is satisfied:
0.4<f1/f<1.5
where f is a focal length of the optical system, and f1 is a focal length of the first lens unit.

3. The optical system according to claim 1, wherein the following inequality is satisfied:
−1.0<f2/f<−0.3
where f is a focal length of the optical system, and f2 is a focal length of the second lens unit.

4. The optical system according to claim 1, wherein the following inequality is satisfied:
0.8<f3/f<5.0
where f is a focal length of the optical system, and f3 is a focal length of the third lens unit.

5. The optical system according to claim 1, wherein the following inequality is satisfied:
0.5<f4/f<4.0
where f is a focal length of the optical system, and f4 is a focal length of the fourth lens unit.

6. The optical system according to claim 1, wherein the second lens unit is moved toward the image side during focusing from infinity to the shortest distance.

7. The optical system according to claim 1, wherein the third lens unit is moved toward the object side during focusing from infinity to the shortest distance.

8. The optical system according to claim 1, wherein the following inequality is satisfied:
−1.5<M3/M2<0.0
where a direction moving from the object side to the image side is set positive, M2 is a moving amount of the second lens unit relative to the image plane during focusing from infinity to the shortest distance, and M3 is a moving amount of the third lens unit relative to the image plane during focusing from infinity to the shortest distance.

9. The optical system according to claim 1, wherein the following inequality is satisfied:
0.5<(rf+rr)/(rf−rr)<1.5
where rf is a radius of curvature of a lens surface on the object side of a lens disposed closest to the object in the second lens unit, and rr is a radius of curvature of a lens surface on the image side of a lens disposed closest to the image plane in the second lens unit.

10. The optical system according to claim 1, wherein a distance on an optical axis between the second lens unit and the third lens unit is the longest distance of all distances on the optical axis between adjacent lens units in the optical system.

11. The optical system according to claim 1, wherein the following inequality is satisfied:
0.5<D23/sk<3.0
where sk is a back focus of the optical system in an in-focus state at infinity, and D23 is a distance on an optical axis between the second lens unit and the third lens unit in in the in-focus state at infinity.

12. The optical system according to claim 1, wherein the following inequality is satisfied:
3.0<f4/sk<40.0
where sk is a back focus of the optical system in an in-focus state at infinity, and f4 is a focal length of the fourth lens unit.

13. The optical system according to claim 1, wherein the following inequality is satisfied:
−2.0<fno×f2/f3<0.0
where fno is an F-number of the optical system, f2 is a focal length of the second lens unit, and f3 is a focal length of the third lens unit.

14. The optical system according to claim 1, wherein the second lens unit consists of three lenses or fewer.

15. The optical system according to claim 1, wherein the third lens unit consists of three lenses or fewer.

16. The optical system according to claim 1, wherein the fourth lens unit includes two negative lenses or more.

17. The optical system according to claim 1, wherein the optical system consists of, in order from the object side to the image side, the first lens unit, the second lens unit, the third lens unit, and the fourth lens unit.

18. An image pickup apparatus comprising:
an optical system; and
an image sensor configured to receive an image formed by the optical system,
wherein the optical system includes, in order from an object side to an image side, a first lens unit having positive refractive power, a second lens unit having negative refractive power, a third lens unit having positive refractive power, and a fourth lens unit having positive refractive power,
wherein during focusing, the first lens unit and the fourth lens unit are fixed, and the second lens unit and the third lens unit are moved,
wherein the first lens unit includes a positive lens disposed closest to an object, and
wherein the fourth lens unit includes a negative lens disposed closest to an image plane.
